(19) United States
(12) Patent Application Publication
(10) Pub. No.: US 2007/0108757 A1
(43) Pub. Date: May 17, 2007

(54) Security laminate intermediate using distinct infrared light spectrum verification capability

(75) Inventor: Roger D. Buck, Pittsburg, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/280,617

(22) Filed: Nov. 16, 2005

(51) Int. Cl. B42D 15/00

(52) U.S. Cl. 283/72

(57) ABSTRACT

The present invention is directed towards a business communication intermediate that uses a pre-determined pattern of taggant ink dispersed in a pressure sensitive adhesive that is applied to a carrier web or substrate. The adhesive has a printed layer that is applied over the adhesive in a manner that does not obscure detection of the underlying taggant ink. The intermediate may then be used in the manufacture of a number of business communication products so as to provide a security feature that may be made integrally with the communication products. The business communication assembly may be provided in an intermediate format, such as in a continuous web configuration that may be reduced to individual intermediate portions.

### CROSS-REFERENCES TO RELATED APPLICATIONS

None.

### FIELD OF THE INVENTION

The present invention relates to a security laminate that contains a verification feature that is outside of the visible light spectrum. More particularly, the present invention relates to an intermediate business communication platform in which authenticity of the of the security features can be obtained through reading of radiation wavelength levels of between about 700 nanometers and about 1 millimeter approaching the red end of the spectrum. The intermediate produced in accordance with the embodiments described in the specification may be used in the fabrication of various business communication vehicles, including cards, tags, certificates, redemption items, passes, admittance badges and other items in which it may behoove the supplier to provide some level of security in the issued documents.

The assembly described herein may be produced in several intermediate configurations ranging from a continuous web arrangement having a plurality of separable individual laminates to a single laminate intermediate. The construction includes an adhesive coated substrate such as a carrier web to which a predetermined pattern of detectable ink in the infrared spectrum is dispersed in the adhesive. A printed over lay is applied over the adhesive and ink to create an intermediate laminate configuration.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and new information handling needs of businesses and consumers alike.

The office or business products markets currently include a number of products that have security features. Such business documents have been supplied with various features that have security attributes contained on or in the particular document and which are intended to defeat attempts at fraudulent manipulation. Some of the more common products found in the marketplace include anti-photocopy protection, wherein when an attempt is made to make a photocopy of the original product, the copy of the original is supposed to have some word or other feature appear such as “VOID” or “COPY” which shows that the document is not the original. This process may be achieved through use of various sized dots, lines or other figures or elements which cause difficulty with the image resolution of a photocopier thereby creating the security feature on the copy of the document.

Other security features have included micro-printing in which a security word or other word or phrase is printed on a face of the document by utilizing an extremely small font size so that the message cannot be readily realized by the naked eye or by using a scanner or photocopier.

Chemical reagents have been used to show attempts at chemical alteration such that a “brown” discoloration or other stain will appear on the document on exposure to the alteration chemicals that may be used to remove or change information on the document such as the monetary amount that may appear on the face of a negotiable instrument. However, while effective with certain chemicals, the reagents may not work with all chemicals or substances that may be utilized to alter a document.

Still other security features have included holograms, seals, tags, watermarks, security threads and the like that are provided in or on the document and can be used to verify the authenticity of a document. Problems with these features include the ability to easily replicate or even replace the hologram, label or seal with sufficient accuracy so that there is no readily discernable difference between the original and copy or to simply remove the feature such as by scraping or abrasion so that does not appear that such a feature was originally provided with the document.

Some of the difficulties associated with such prior art security solutions include that the solutions, such as holograms or seals, are either visible by the naked eye or can be discovered through easily obtainable means such as a magnifying glass. Thus, where an individual desires to attempt nefarious production of a document and the individual can readily detect the security feature, creating a copy or design around of the security feature on such a product becomes that much easier as the individual has knowledge of the feature that must be defeated in order to produce fraudulent copies.

The market for printed materials is also changing and becoming significantly more sophisticated. Conventional business forms manufacturers have normally produced product runs that range in the hundreds of thousands to millions or even tens of millions of pieces for a single order. Such large production runs often were devoid of any specificity or unique features as economies of scale were achieved by manufacturers in generating large quantities of relatively indiscreet product. In addition, the marketplace may simply not have demanded as much security against fraud as may now be dictate by financial and insurance institutions. Alternatively, in those instances when a security feature is provided it may have been one which is easy to reproduce and suffers from the drawbacks enumerated above.

A still further drawback of trying to migrate to smaller or individualized customer applications that include special features and characteristics relate to quality of the pieces that need to be generated. With the focus of the market shifting to smaller runs and the level of personalization increasing, the end user is now demanding a greater image quality than that typically associated with conventionally printed products as well as the need to create products that have varying degrees of security which are increasingly difficult to thwart. Thus, the manufacturer may simply not be able to add conventional security features to the printed communications as the feature reduces the quality or appearance of the business communication or alternatively, the feature limits the available space used for communicating a message to a recipient.

It is believed that one of the reasons for such far reaching changes in the printing industry is that end users want more from each piece that is produced rather than relying on the quantity of pieces to generate the desired result. In addition, marketers want to make a greater impact at every turn in the retail chain to try and maximize the chances for purchases of a particular product being offered by the printed piece. This demand must be weighed in combination with the increasing demand to mitigate losses that occur through fraud and the sophistication of those that participate in such activities.

With the change in focus to quality as opposed to quantity there are a number of products or applications that to date are still out of reach of conventional manufacturers in that certain items simply cannot be handled by conventional printing equipment and forms processing apparatus. That is, where a small order for multiple items is presented to a manufacturer, the traditional manufacturer would have to set up multiple pieces of fulfillment equipment as opposed to being able to run a multipart order through a single or very few pieces of equipment. The process is further exacerbated if the customer requires a security feature be added to the business communication piece. In addition, where a consumer wants to procure a number of distinct items that are printed at a relatively high resolution and which have one or more security features in the product makes attainment of such products increasingly difficult for the manufacturer.

Thus, what is needed in today's rapidly changing market for printed documents is a business communication intermediate platform that can be easily included in one or more distinct finished business communication pieces by conventional manufacturers of printed products and which provides a reliable security feature that remains substantially hidden from view from the casual observer but which may be readily revealed through use of convenient detection means.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that a unique security laminate intermediate may be produced having a specific security feature that is not visible in the visible light spectrum and which instead may only be detected in the infrared spectrum and which has wavelengths greater than about 700 nanometers to about 1 millimeter.

Taggant ink may be dispersed in or on a pattern of adhesive in a particular predetermined pattern that ranges from a random dispersion to relatively regimented or arranged geometric configurations. The security ink may then be covered by one or more concealing patterns or layers of over print or printed material which will not prevent the underlying taggant ink from being easily detected or being obscured when activation of the detection energy is used. The over printed layer may also contain additional security features such as anti-photocopy patterns and the like.

In one exemplary embodiment an intermediate for use in printed business communications is provided and includes a first substrate that has first and second faces with a pressure sensitive adhesive coated onto at least one of the first and second faces of the substrate. A taggant ink is then dispersed in a pattern on or within the adhesive that has been coated onto one of the first and second faces. The taggant ink used in connection with the present invention has a wavelength of greater than about 700 nanometers to about 1 millimeter in length.

In the presently described embodiment, a partially printed layer is then provided on a second substrate first face and is applied substantially over the adhesive coated face of the substrate in order to form a business communication intermediate. The printed over layer does not obscure detection of the taggant ink when a certain activation energy is used to detect the presence of the security ink.

In yet a further exemplary embodiment of the present invention, a business communication, is described and includes a printed business communication substrate, with the substrate having first and second faces, first and second longitudinally extending sides and first and second transversely extending edges. The longitudinally extending sides and the transversely extending edges define an area of the printed business communication substrate.

A pressure sensitive adhesive is applied to at least one of the first and second faces, in a portion of the business communication substrate that is less than the area of the printed business communication substrate. The adhesive includes a taggant ink that is invisible in visible light spectrum and is dispersed in a predetermined pattern within the adhesive. A printed layer is disposed substantially over and covers the entire pressure sensitive adhesive.

In a yet still further exemplary embodiment of the present invention, a business communication intermediate assembly is described and includes a continuous carrier web, the web has first and second sides and first and second transversely extending edges and a release coating provided on the first side. A pattern of pressure sensitive adhesive is applied to at least a portion of the first side over the release coating. A predetermined pattern of taggant ink is applied to the adhesive and runs substantially parallel to the first and second transversely extending edges of the continuous carrier web.

In the presently described embodiment, a series of distinct repeating printed patterns is provided with the printed patterns running substantially parallel to the first and second transversely extending edges of the continuous carrier web. The series of repeating printed patterns are positioned substantially over the predetermined pattern of taggant ink to form a series of business communication intermediate assemblies. The carrier web may be provided with a series of regularly occurring marks, such as timing marks or registration marks to aid in the lay down or application of the overprinting or over layer.

In connection with each of the foregoing embodiments, the over layer or printed layer may also be provided with first and second designs patterns with the first pattern extending a distance greater in a direction that runs parallel to the transverse edges than the second design or pattern. The patterns, when provided in a continuous web arrangement will be regularly occurring or repeating. In addition, the overlay or over printing may also be provided with cuts, slits, perforations or combinations thereof to further provide evidence of tampering, alteration or attempts and nefarious activity when one attempts to remove the laminate assembly from the business communication piece.

Preferably, when the security laminate is used in connection with a business communication piece, the communication piece will be printed at a resolution of greater than about 150 lines per inch.

In a further possible embodiment of the present invention, the security intermediate laminate described above may be included in a pre-packaged kit such that a manufacturer can apply individual intermediate laminates to business communication pieces at a distinct location from where there intermediate has been manufactured. The package or kit, in addition to a sheet or web carrying a number of individual security laminates and a shipping or delivery carton, may also include a means by which to activate and detect the presence of the security laminate, such as an source that can generate energy to detect the presence of the security feature.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of a security laminate produced in accordance with the present invention;

FIG. 1A presents and alternate view of the cross sectional view of a security laminate shown in FIG. 1 and produced in accordance with the present invention;

FIG. 2 illustrates a front view of a carrier web showing a number of security laminates produced in accordance with the present invention;

FIG. 3 shows an exemplary use of the present invention and activation of the security feature; and

FIG. 4 provides a further exemplary embodiment of the present invention in which a package including security laminates and detection equipment is provided.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The present invention is directed to a unique security laminate that may be produced in a number of different configurations for use with printed business communications. The security feature contained in the laminate assembly is provided through the use of a taggant ink material that is incorporated on or in the adhesive which is then applied to a carrier web, such as a release liner or the like. The taggant material, which is not visible in the visible light spectrum since its wavelengths fall to the infrared range, i.e. between about 700 nanometers and 1 millimeter may be further concealed such as by over printing or over layering the taggant material to further conceal it from tampering or alteration. The taggant material and over layer may be applied in a direction that runs substantially parallel to the transversely extending edges.

Business communications are ones that preferably in today's market are provided with imaging or printing at a relatively high resolution. Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide images on a substrate that has a resolution quality of about 150 or more lines per inch and preferably more than 300 lines per inch, which is approximately equal to about 2500 to 3500 dots per inch (“DPI”) in order to create a high quality image that is intended to be aesthetically appealing to the consumer. Other imaging equipment may of course be used depending on the sheet or web size that the equipment can efficiently handle.

As used herein the term “business communication” is used to refer to a printed or imaged piece, document or substrate that when used with the a laminate as described in the present invention will convey a particular message, image or provide information about a particular product or service that is available from the provider of such pieces or documents. Business communications, documents or pieces can include advertising, sales and marketing collateral and such other items used to convey information, and in connection with the present invention also include cards, certificates, tags, ticket, redemption coupons, labels, passes, badges and combinations of the foregoing.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering, laminating and the like. Typically, a product such as with the present invention is provided in an intermediate condition so that a user or downstream manufacturing point can add or manipulate the intermediate to create the final or desired end product, such as creating a finished security or entrance badge, pass, ticket or the like. Thus, in accordance with the present invention, the intermediate segment for example, could be subject to die cutting or additional printing, such as through ink jetting, over laminating, coating or embossment, and then applied to a blank for further processing, such as a badge, pass, ticket, certificate and the like.

The term “blank” as used herein refers to a substrate which may either be cut to the final useable configuration, or alternatively, may be cut or severed from a web to be used as the base to which the security laminate intermediate is applied for completing the business communication of the presently described invention. For example, a blank can include cards, tags, certificates, tickets, badges, passes and the like.

The over layer that may be used as the printed over lay or to carry the printing and that which is applied over the top of the adhesive may be constructed from any suitable substrate or material such as a cellulosic based substance, synthetic film, foil or the like. The over lay material should be one that will preferably not obscure or obstruct the detection of the security feature, such as by utilization of an energy source that will cause the security material to become visible and allow certain wavelengths to be seen during activation.

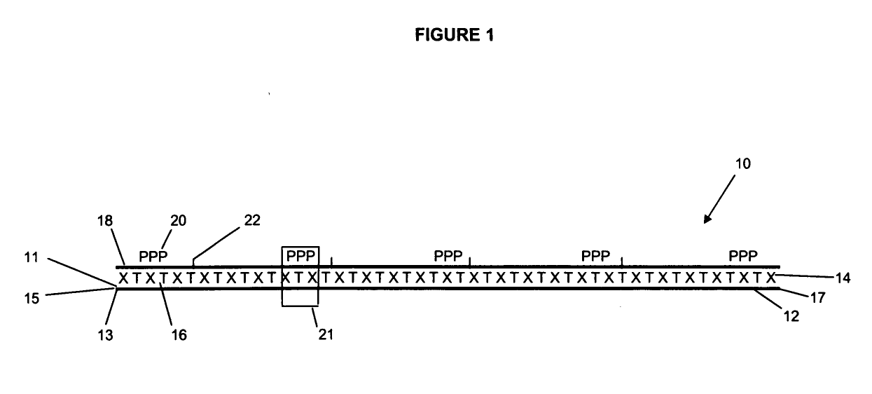

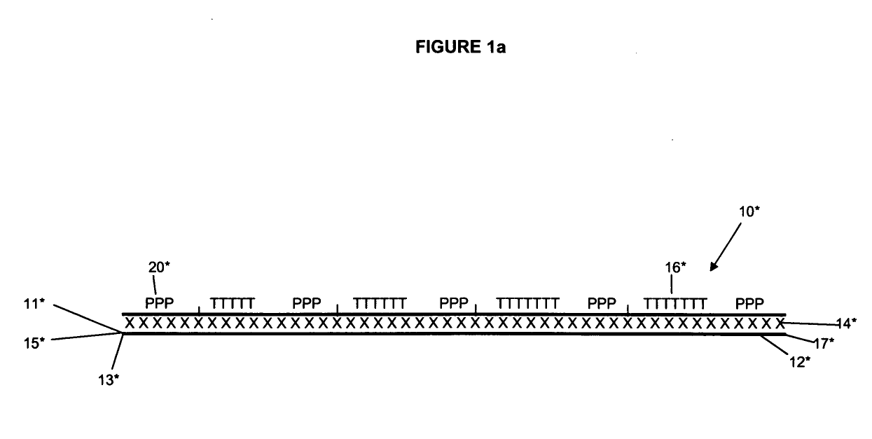

Reference is now directed to FIG. 1 of the presently described embodiment of the instant invention. FIG. 1 show a cross sectional view of a portion of a laminate and is generally depicted by reference to numeral 10. The laminate 10 includes a substrate, such as a release coated carrier web, 12, that has first and second faces 11 and 13. A pattern of adhesive 14 and depicted in the drawing by using letter reference “X” and the adhesive 14 is applied to the first face 11 of the substrate 12. The first face 11 will preferably have a release coating applied thereto, such as silicone, wax or other suitable material, so as to permit the security laminate intermediate 10 to be easily removed from the carrier web 12 and applied to a blank by use of the adhesive 14 to construct the final configuration of the business communication assembly. The carrier web is provided with first and second longitudinally extending edges 15 and 17 and first and second transversely extending edges (not shown in FIG. 1).

FIG. 1 also shows the taggant ink 16. The taggant ink 16 is represented by the letter reference “T”. The taggant ink 16 is shown in a relatively regularly occurring pattern that is dispersed on or within the adhesive 14. It should be understood that in addition to the regular appearance of the pattern shown in FIG. 1 that any sort of pattern may be used ranging from completely random to structured geometric configurations and patterns. For example, the taggant ink could be used to create a pattern representing words or symbols to further thwart attempted duplication and copying attempts.

Disposed over the combined surface of the pattern of adhesive 14 and the dispersed taggant ink 16 contained within the adhesive, and represented by the characters “XTXTXT . . . ” is an overlay 18 which may be made from any suitable material. In an exemplary embodiment, the overlay 18 is a synthetic film such as PET or other relatively inexpensive polyester or polyolefin based film that is also durable and one that will accept toner and/or ink. The film may also be treated with a surface modifying material such as polyvinyl alcohol to enable better ink hold out or toner anchorage.

The overlay 18 in the presently described FIG. 1 is printed with various images or textual information 20 and which is represented by the characters “PPP.” In addition, the overlay 18 may also be provided with slits or cuts 22 that can be used to identify individual laminate intermediates or alternatively to serve as an additional security feature such that after application of the intermediate 10 to a blank, any attempted removal of the intermediate will cause the intermediate to fracture or break thus showing tampering of the business communication and alerting the user to or issuer to possible fraudulent activity.

FIG. 1 also provides in the area highlighted by reference numeral 21 that the printing 20 in one exemplary embodiment, is provided directly over a portion of the pattern of taggant material 16. In this arrangement, an issuing branch or other area that is to be used in clearing the blank to which the laminate intermediate has been applied can then know where to inspect the blank to determine if the security feature is present in the business communication.

The laminate shown in FIG. 1A 10* includes a substrate, such as a release coated carrier web, 12*, that has first and second faces 11* and 13*. A pattern of adhesive 14* and depicted in the drawing by using letter reference “X” and the adhesive 14* is applied to the first face 11* of the substrate 12*. The first face 11* will preferably have a release coating applied thereto, such as silicone, wax or other suitable material, so as to permit the security laminate intermediate 10* to be easily removed from the carrier web 12* and applied to a blank by use of the adhesive 14* to construct the final configuration of the business communication assembly. The carrier web is provided with first and second longitudinally extending edges 15* and 17* and first and second transversely extending edges (not shown in FIG. 1).

FIG. 1A also shows the taggant ink 16*. The taggant ink 16* is represented by the letter reference “T”. The taggant ink 16* is shown in a relatively regularly occurring pattern that is dispersed on or within the printing 20*. It should be understood that in addition to the regular appearance of the pattern shown in FIG. 1A that any sort of pattern may be used ranging from completely random to structured geometric configurations and patterns. For example, the taggant ink could be used to create a pattern representing words or symbols to further thwart attempted duplication and copying attempts.

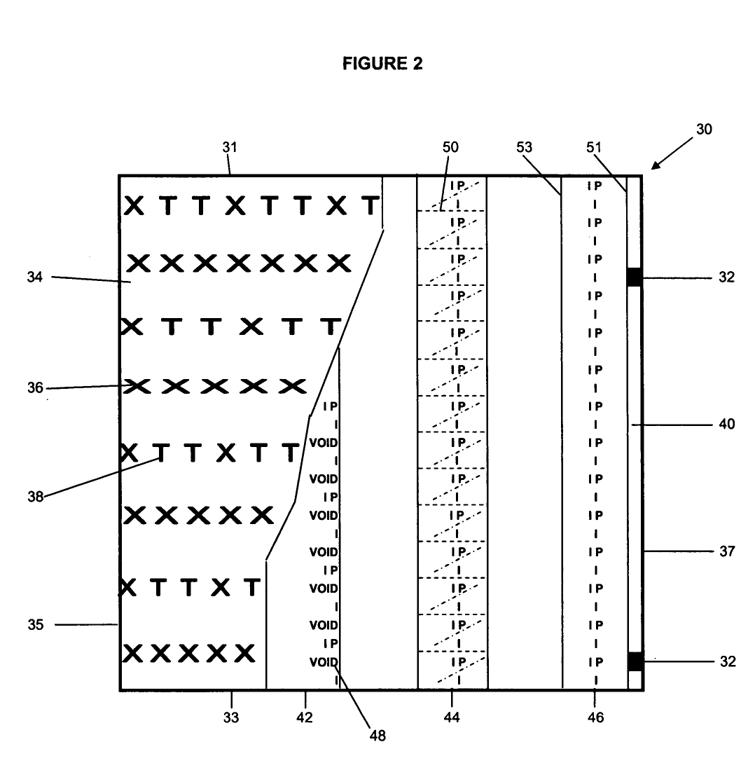

FIG. 2 shows a series of security intermediates provided on a continuous carrier web and illustrates another possible deliverable application of the present invention. The sheet, generally depicted by reference to numeral 30. The sheet 30 may include a number of regularly spaced timing or registration marks 32 which may aid the manufacturer in placement of the printing, imaging, adhesive and the like as well as determine run lengths and for verification and quality assurance purposes. The registration marks may also be used to align the pattern of taggant ink with the pattern of printing appearing on the overlay.

As shown in FIG. 2, the sheet assembly 30 is provided with a carrier substrate or release sheet 34 which is provided with a pattern of pressure sensitive adhesive 36, represented by the character “X” in the drawing. Interspersed in the adhesive pattern 36 is a taggant ink material 38 which is represented by the character “T” in the drawing. The pattern of application of the taggant ink 38 may be random or alternatively, the pattern may be laid down in a prescribed pattern and create geometric configurations, such as blocks of ink.

The assembly 30 has first and second transversely extending edges 31 and 33 and first and second longitudinally extending sides 35 and 37. It should be readily understood that each substrate of the assembly 30 will have first and second faces. It should also be understood that while a sheet configuration is presented, that the assembly may be produced in a continuous format such as a roll configuration or fan folded type of arrangement.

Preferably, in one embodiment, the patterns created by placement of the taggant ink will correspond directly with a pattern printed on an overlay material 40 as will be herein described. That is, the pattern of taggant ink will be directly beneath the printed pattern. The registration marks 32 may thus be used in maintaining registry of the taggant pattern in the adhesive layer and the printed overlay. In this way, one attempting to authenticate the business communication document one would look for a particular printed pattern in the overlay and apply the inspection device to that area. Alternatively, the pattern of taggant ink may be completely random and may not necessarily appear directly beneath a portion of a certain printing, but will preferably be still in within the area of the laminate.

FIG. 2 further shows printed on the overlay 40 at least three rows of security intermediate laminates 42, 44 and 46. The individually printed rows 42, 44 and 46 of the overlay are shown as running generally parallel to the first and second longitudinally extending sides 35 and 37. Obviously, the orientation of the printed rows may run parallel to the first and second transversely extending edges or at diagonals to the sides or edges or may be dispersed in any sort of arrangement that would allow the individual intermediate security laminates to be removed from the sheet assembly 30.

Each of the rows of printing 42, 44 and 46 are shown with first and second printed patterns of information or designs, which are represented by the characters “I” for the first printed design and “P” for the second printed design. As shown in FIG. 2, the first printing design “I” runs substantially the entire length of each of the rows, whereas the second design “P” appears at certain intervals, that is the first printed design runs a first length that is greater than the second printed design which runs a second length that is substantially less than the first length.

Row 42 of FIG. 2 is also illustrated as having an additional security feature 48 such as an anti-photocopy feature in which the word “VOID” will appear upon attempted photocopying. In addition, the use of this additional feature may be used to distract an individual engaging in nefarious activity, thereby focusing their attention on this feature and thus not looking for the underlying security taggant ink feature.

Row 44 of FIG. 2 is shown with a number of cuts, slits, perforations or combinations thereof 50 which can be used to separate the individual laminates from the sheet assembly 30 as well as to provided an additional security feature. The slits that run through the length of the printed pattern, in this example designated by the characters “IP” and “I”, will preferably cause the laminate to break apart when attempting to remove the security laminate from the surface of the blank to which it is applied.

Each of the rows of printed material 42, 44 and 46 may each be provided with lines of weakness 51 and 53 which will enable a user or manufacturer to strip out the rows from the sheet assembly 30 to be used in application to the blanks of material that are to be ultimately produced. It should be understood that the lines of weakness 51 and 53 as well as those between individual portions of the intermediate laminate will be sufficiently weak such that removal or separation will not cause the security slits in the rows to be broken thus rendering the intermediate materials unusable.

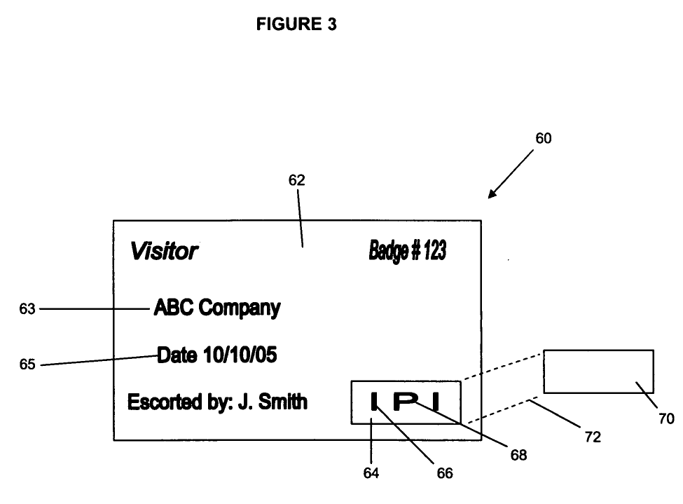

Reference is now directed to FIG. 3 of the embodiments of the presently described invention. In FIG. 3 a card blank, such as one that may be used in the creation of badges or passes is generally designated by reference to numeral 60 is displayed. It should however be understood that any sort of blank that is suitable for forming a business communication may be used, including but not limited to certificates, tickets, cards, coupons, passes and combinations thereof. The card illustrated in the present drawing may have a size ranging from about 3⅜ inches wide to about 2⅛ inches in length.

The surface 62 of the card 60 which in the present example is being used as an entry pass or badge may be printed with static or fixed information 63, such as the company name, and other fixed fields as well as personalized information 65 such as the date and escorted by information. To the surface 62 of the card blank 60 an individual security laminate 64 has been applied. The laminate 64 shows the printed pattern 66 provided on the face of the laminate as well as a security slit 68 which extend across the face of the laminate material. Attempted removal of the laminate will preferably cause the laminate to break into two sections in the area of the slit.

FIG. 3 also shows a reader device 70 which produces an energy 72 that enables detection of the underlying taggant ink thereby permitting the inspector of the business communication document to verify the authenticity of the documents that have been presented. In use of the reader, a color that is distinct from the surrounding printing or overlay will typically appear showing the presence of the taggant ink.

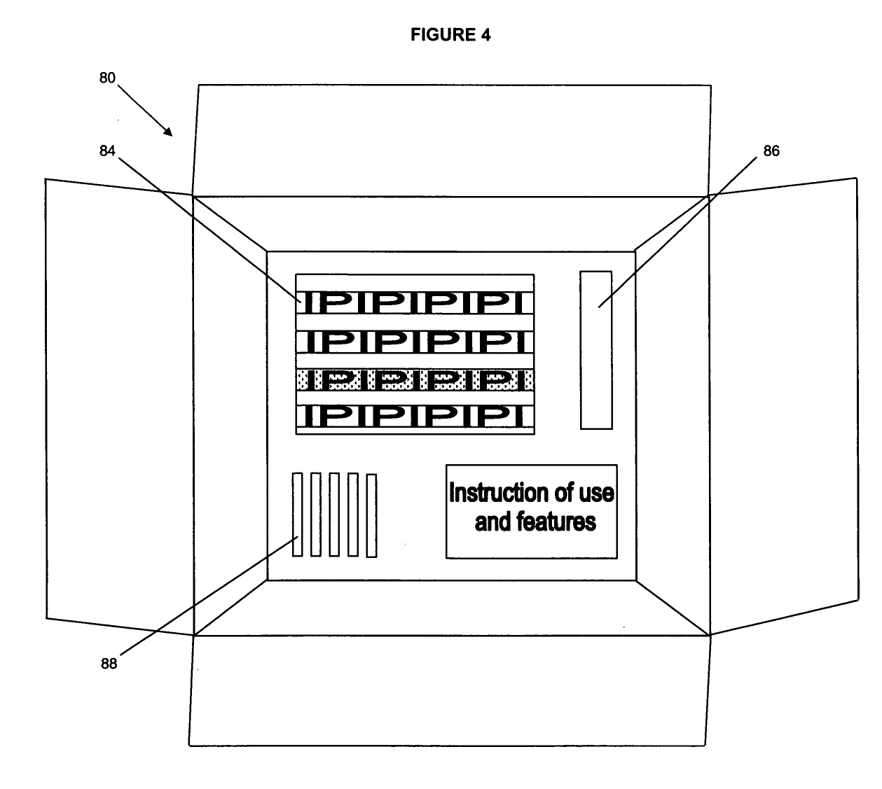

FIG. 4 is presented to show a further exemplary embodiment of the present invention in which a package 80 is provided. The package 80 may be any suitable shipping or delivery package or carton. FIG. 4 illustrates an open package 80 which includes a series of instructions 82 for use of the security laminate. A supply of the security laminates has been provided in the package 80 and is designated by reference numeral 84. The laminate material 84 may be provided in a single sheet, a roll of material, or the individual security laminates may be already separated from the carrier web or sheet assembly.

The package 80 also includes in this exemplary embodiment a detection device 86 which is used to verify the presence of the taggant material when applied to the business communication. In addition, the kit or package 80 may also include a series of blanks 88 that may be used by the recipient and thus providing a complete kit or package to the customer. Alternatively, the customer may supply his or her own blanks of material for use in carrying out use of the security laminate intermediate.

It will thus be seen according to the present invention a highly advantageous business communication intermediate having a distinctly detectable security feature has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. An intermediate for use in printed business communications, comprising;
a first substrate having first and second faces;
a pressure sensitive adhesive coated onto at least one of said first and second faces of said substrate; and
a taggant ink dispersed in a pattern that is coated onto one of said first and second faces and said taggant ink having a wavelength of greater than about 700 nanometers; and
a partially printed layer provided on a second substrate first face is applied substantially over said adhesive coated face of said substrate to form a business communication intermediate such that said printed over layer does not obscure detection of said taggant ink.

2. An intermediate as recited in claim 1, wherein said taggant ink is dispersed in a pattern within said adhesive.

3. An intermediate as recited in claim 1, wherein said taggant ink is dispersed in a pattern on said partially printed layer.

4. An intermediate as recited in claim 1, wherein said taggant ink is disposed directly beneath a portion of said partially printed layer.

5. An intermediate as recited in claim 1, wherein said printed layer is prepared at a resolution of greater than about 150 lines per inch.

6. An intermediate as recited in claim 1, wherein said business communication intermediate may be used in preparing a finished business communication selected from a group including cards, coupons, redemption certificates, badges, passes, tickets, tags and combinations thereof.

7. An intermediate as recited in claim 1, wherein said substrate is a release coated carrier web having a series of regularly spaced timing marks.

8. An intermediate as recited in claim 1, wherein said partially printed layer is provided with a series of slits, cuts, perforations or combinations that extend through said layer.

9. A business communication, comprising;
a printed business communication substrate, said substrate having first and second faces, first and second longitudinally extending sides and first and second transversely extending edges, said longitudinally extending sides and said transversely extending edges defining an area of said printed business communication substrate;
a pressure sensitive adhesive applied at least to one of said first and second faces, in a portion of said business communication substrate that is less than said area of said printed business communication substrate, said adhesive including a taggant ink invisible in visible light spectrums and dispersed in a pre-determined pattern within said adhesive; and
a printed layer disposed substantially over and covering all of said pressure sensitive adhesive.

10. A business communication as recited in claim 9, wherein said printed business communication is produced at a resolution of greater than about 150 lines per inch.

11. A business communication as recited in claim 9, wherein said printed layer is produced at a resolution of greater than about 150 lines per inch.

12. A business communication as recited in claim 9, wherein said business communication is selected from a group including cards, coupons, redemption certificates, badges, passes, tickets, tags and combinations thereof.

13. A business communication as recited in claim 9, wherein said printed layer is provided with a series of slits, perforations, cuts or combinations thereof that extend through said layer.

14. A business communication intermediate assembly, comprising;
a continuous carrier web, said web having first and second sides and first and second transversely extending edges and first and second longitudinally extending sides and a release coating provided on said first side;
a pattern of pressure sensitive adhesive applied to at least a portion of said first side over said release coating;
a predetermined pattern of taggant ink applied to said adhesive and running substantially parallel to said first and second transversely extending edges of said continuous carrier web; and
a series of distinct repeating printed patterns, said printed patterns running substantially parallel to one of said first and second transversely extending edges or said first and second longitudinally extending sides of said continuous carrier web and said series of repeating printed patterns positioned substantially over said predetermined pattern of taggant ink to form a series of business communication intermediate assemblies.

15. A business communication intermediate assembly as recited in claim 14, wherein each printed pattern in said series of repeating printed patterns are substantially identical to one another.

16. A business communication intermediate assembly as recited in claim 14, wherein each printed pattern has a pattern of taggant ink disposed directly beneath each said printed pattern.

17. A business communication intermediate assembly as recited in claim 14, wherein said series of repeating printed patterns is provided on a substrate having first and second sides such that said second side is provided over said pattern of pressure sensitive adhesive.

18. A business communication intermediate assembly as recited in claim 14, wherein said substrate with said series of repeating printed patterns is placed over said predetermined pattern of taggant ink.

19. A business communication intermediate assembly as recited in claim 14, wherein said repeating printed patterns have first and second printed designs disposed substantially over one another.

20. A business communication intermediate assembly as recited in claim 19, wherein said first printed design extends a first distance that is greater than a distance of said second printed design.
